(19) United States
(12) Patent Application Publication
(10) Pub. No.: US 2026/0280280 A1
(43) Pub. Date: Sep. 17, 2026

(54) CONTROL CIRCUIT, ELECTRICAL APPARATUS AND EQUIPMENT

(71) Applicant: CANON KABUSHIKI KAISHA, Tokyo (JP)

(72) Inventor: WENYING YE, Tokyo (JP)

(21) Appl. No.: 19/468,544

(22) Filed: Feb. 3, 2026

(30) Foreign Application Priority Data
Feb. 6, 2025 (JP) 2025-018568

(51) Int. Cl. H02J 1/08; G03B 5/00; H04N 23/68

(52) U.S. Cl. CPC H02J 1/084; G03B 5/00; G03B 2205/0007; G03B 2205/0069; H04N 23/687

(57) ABSTRACT

A control circuit for controlling a load circuit includes a semiconductor element with a first switching element and a second switching element integrated therein, a first capacitor, a second capacitor and a circuit substrate. The first switching element connects a first output line connected to a first terminal of the load circuit and a first power supply line, and opens/closes current to the load circuit. The second switching element is connected between a second output line connected to a second terminal of the load circuit and a second power supply line, and opens/closes current to the load circuit. The first capacitor connects the first power supply line and the first output line. The second capacitor connects the second power supply line and the second output line. The semiconductor element, the first capacitor, and the second capacitor are mounted on the circuit substrate.

### BACKGROUND

### Field of the Technology

The present disclosure relates to a control circuit, an electrical apparatus and equipment.

### DESCRIPTION OF THE RELATED ART

Conventionally, a load drive device is provided with a phase switching circuit that switches phases of two windings of a stator in a two-phase stepping motor, as an example of a load element, and a switching element adjusts a pulse width so that current flowing in the windings becomes constant.

Japanese Patent Laid-Open No. 2003-189592 discusses a motor drive circuit provided with a switching element capable of controlling power supplied to an electric motor.

Recently, the switching frequency of the switching element is increased in high frequency for the purpose of high-precision control and miniaturization of a load element. The increase in the switching frequency can worsen the influence of radiated noise including a high-frequency component.

### SUMMARY

The present disclosure is directed to a technique advantageous for reducing radiated noise of a control circuit.

An aspect of the present disclosure provides a control circuit for controlling a load circuit, the control circuit including a semiconductor element, a first capacitor, a second capacitor and a circuit substrate. The semiconductor element has a first switching element and a second switching element integrated therein. The first switching element is connected between a first output line connected to a first terminal of the load circuit and a first power supply line, and is configured to open and close flow of current to the load circuit. The second switching element is connected between a second output line connected to a second terminal of the load circuit and a second power supply line, and is configured to open and close flow of current to the load circuit. The first capacitor is connected between the first power supply line and the first output line. The second capacitor is connected between the second power supply line and the second output line. The semiconductor element, the first capacitor, and the second capacitor are mounted on the circuit substrate.

Features of the present disclosure will become apparent from the following description of embodiments with reference to the attached drawings. The following description of embodiments is described by way of example.

### BRIEF DESCRIPTION OF THE DRAWINGS

FIG. 1A is a circuit diagram illustrating a control circuit according to a first embodiment.

FIG. 1B is a circuit diagram illustrating the control circuit according to the first embodiment.

FIG. 2A is a cross-sectional view illustrating the wiring layout of a circuit substrate in the control circuit according to the first embodiment.

FIG. 2B is an overhead view illustrating the wiring layout of the circuit substrate in the control circuit according to the first embodiment.

FIG. 3A is a circuit diagram illustrating a control circuit according to a second embodiment.

FIG. 3B is an overhead view illustrating the wiring layout of a circuit substrate in the control circuit according to the second embodiment.

FIG. 4 is a cross-sectional view illustrating the wiring layout of a circuit substrate in a control circuit according to a third embodiment.

FIG. 5A is a cross-sectional view illustrating the wiring layout of a circuit substrate in a control circuit according to a fourth embodiment.

FIG. 5B is an overhead view illustrating the wiring layout of the circuit substrate in the control circuit according to the fourth embodiment.

FIG. 6 is a graph showing radiated noise generated from a control circuit.

FIG. 7 is a schematic diagram illustrating an imaging apparatus as an example of electronic equipment according to a fifth embodiment.

FIG. 8A is a circuit diagram illustrating a control circuit according to a reference example.

FIG. 8B is a circuit diagram illustrating the control circuit according to the reference example.

### DESCRIPTION OF THE EMBODIMENTS

### Reference Example

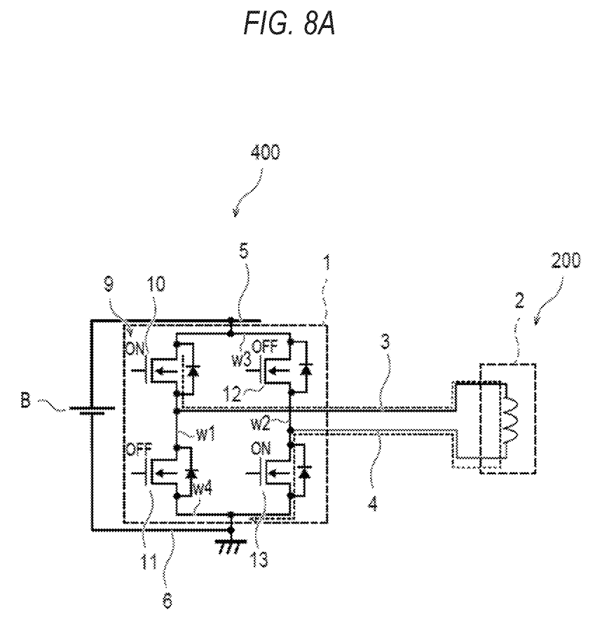

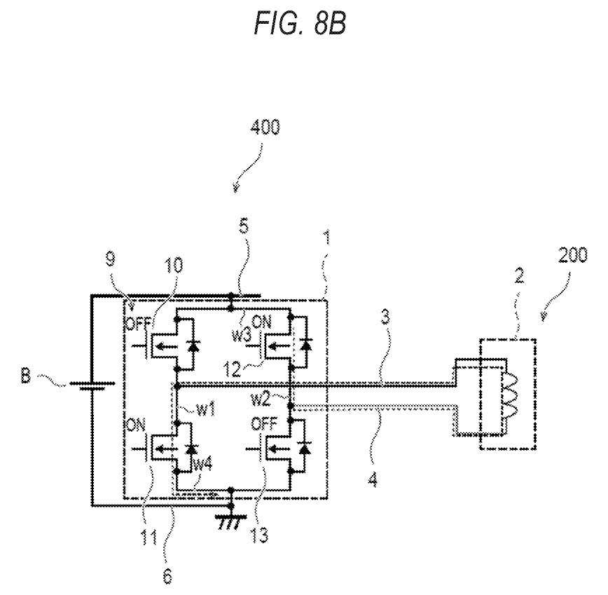

Some radiated noise occurs due to the operation of switching elements. A control circuit according to a reference example in which such radiated noise may occur will be described with reference to FIGS. 8A and 8B. FIGS. 8A and 8B are circuit diagrams illustrating a control circuit 400 according to the reference example. FIGS. 8A and 8B illustrate a case in which driving current is output from output lines 3 and 4 different from each other.

As illustrated in FIGS. 8A and 8B, the control circuit 400 according to the reference example is a control circuit for controlling a load circuit 200 that includes a load element 2 such as a coil or a motor, and may be referred to as a drive circuit that drives the load element 2. The control circuit 400 includes a semiconductor element 1 having one H-bridge drive circuit 9 integrated therein. The semiconductor element 1 is a driver integrated circuit (IC). The control circuit 400 also includes output lines 3 and 4 that connect the semiconductor element 1 and the load element 2 to output driving current to the load element 2, and power supply lines 5 and 6 that connect the semiconductor element 1 and a direct current (DC) power source B to supply power to the semiconductor element 1.

In FIGS. 8A and 8B, the semiconductor element 1 surrounded by a broken line includes transistors 10, 11, 12, and 13 as switching elements, and the output lines 3 and 4. The transistors 10, 11, 12, and 13 are switching elements that open and close current to the load element 2. The transistors 10, 11, 12, and 13 are all N-channel metal oxide semiconductor field effect transistors (MOSFETs).

In the semiconductor element 1, the source of the transistor 10 and the drain of the transistor 11 are connected via a wiring W1. In addition, the source of the transistor 12 and the drain of the transistor 13 are connected via a wiring W2. In addition, the drain of the transistor 10 and the drain of the transistor 12 are connected via a wiring W3. In addition, the source of the transistor 11 and the source of the transistor 13 are connected via a wiring W4. One end of the output line 3 is connected to the wiring W1 between the source of the transistor 10 and the drain of the transistor 11. The other end of the output line 3 is connected to one terminal of the load element 2. One end of the output line 4 is connected to the wiring W2 between the source of the transistor 12 and the drain of the transistor 13. The other end of the output line 4 is connected to the other terminal of the load element 2. The power supply line 5, which is connected to the positive electrode of the DC power source B such as a secondary battery, is connected to the wiring W3 between the drain of the transistor 10 and the drain of the transistor 12. The power supply line 6, which is connected to the negative electrode of the DC power source B, is connected to the wiring W4 between the source of the transistor 11 and the source of the transistor 13. The power supply line 5 is a power supply line that is supplied with a power supply potential by the DC power source B. The power supply line 6 is a ground line that is supplied with a ground potential.

In this manner, the H-bridge drive circuit 9 is configured by the transistors 10, 11, 12, and 13 serving as four switching elements in the semiconductor element 1. In the H-bridge drive circuit 9, the transistor 10 is connected between the output line 3 and the power supply line 5. The transistor 11 is connected between the output line 3 and the power supply line 6, and is connected in series with the transistor 10. The transistor 12 is connected between the output line 4 and the power supply line 5, and is connected in series with the transistor 13. The transistor 13 is connected between the output line 4 and the power supply line 6.

A control unit that controls ON/OFF of the transistors 10, 11, 12, and 13 is connected to the gates of the transistors 10, 11, 12, and 13. The control unit includes a microprocessor that generates voltage signals as control signals for switching ON/OFF of the gates, a gate driver IC that converts the voltages of the control signals from the microprocessor and applies them to the gates, and the like. The control signal for switching ON/OFF of the gate is a pulse width modulation (PWM) signal or the like.

FIG. 8A illustrates a case where the driving current for driving the load element 2 flows through the output line 3 of the semiconductor element 1. In this case, the transistor 10 and the transistor 13 are turned ON, and the transistor 11 and the transistor 12 are turned OFF. In this state, the driving current flows from the power supply line 5 to the load element 2 through the output line 3 via the transistor 10. High-frequency current generated in the transistor 10, which is switched at high speed, also flows to the load element 2 through the output line 3, as indicated by a dotted line.

FIG. 8B illustrates a case where the driving current for driving the load element 2 flows through the output line 4 of the semiconductor element 1. In this case, the transistors 11 and 12 are turned ON, and the transistors 10 and 13 are turned OFF. In this state, the driving current flows from the power supply line 5 to the load element 2 through the output line 4 via the transistor 12. High-frequency current generated in the transistor 12, which is switched at high speed, also flows to the load element 2 through the output line 4, as indicated by a dotted line.

Thus, the high-frequency current flows to the load element 2 through either the output line 3 or the output line 4, regardless of whether the driving current flows through the output line 3 or the output line 4 of the semiconductor element 1. As a result, in the control circuit 400 according to the reference example, radiated noise occurs from the output line 3 or the output line 4 which is a wiring arranged between the semiconductor element 1 and the load element 2.

The control circuit according to embodiments of the present disclosure suppresses the flow of the high-frequency current to the load through the output line even when the high-frequency current is generated by switching the switching element such as a transistor between ON and OFF as described above, thereby reducing radiated noise from the output line. Embodiments of the present disclosure will be described in detail below with reference to the drawings.

### First Embodiment

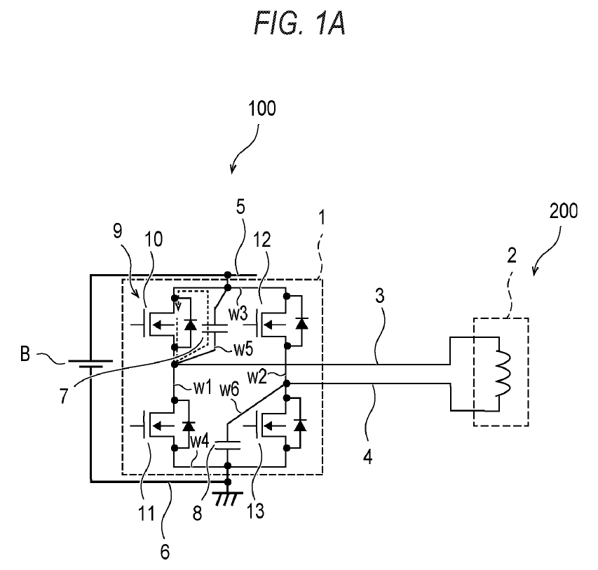

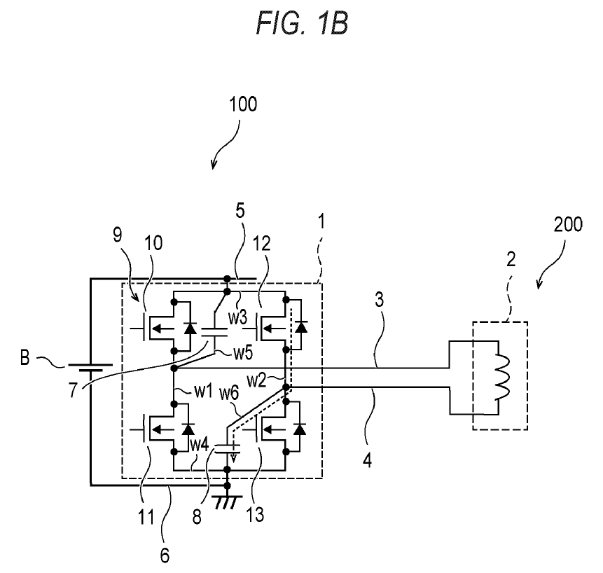

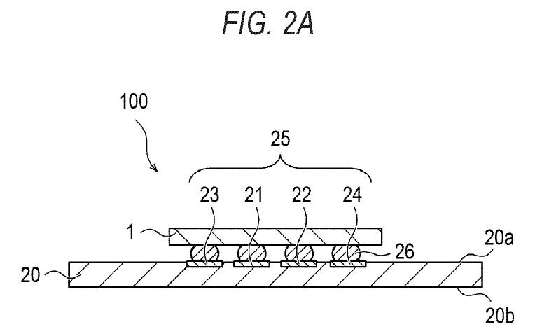

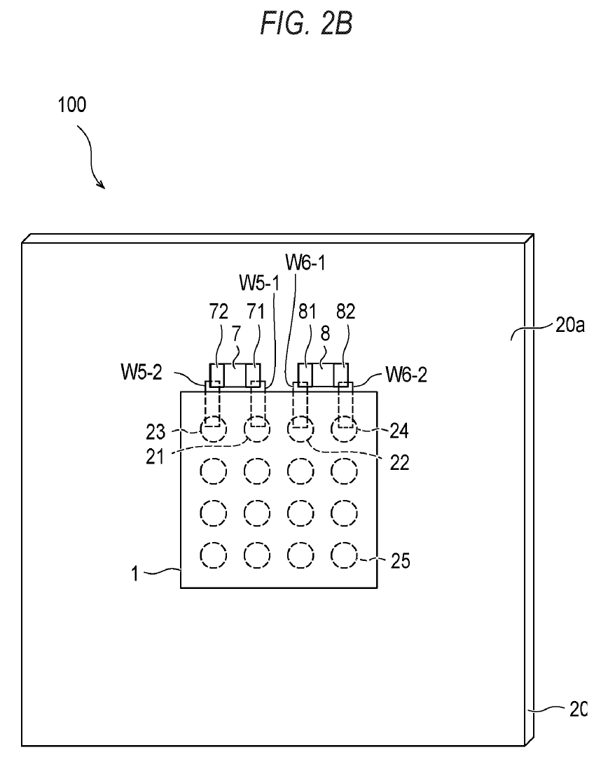

A control circuit according to a first embodiment will be described with reference to FIGS. 1A to 2B. The control circuit according to the present embodiment is applied, for example, to a motor unit mounted in a lens product or a camera product and used for image stabilization or shake correction.

First, the circuit configuration of the control circuit according to the present embodiment will be described with reference to FIGS. 1A and 1B, which are circuit diagrams illustrating a control circuit 100 according to the present embodiment. FIGS. 1A and 1B illustrate a case where driving current is output from output lines 3 and 4 that are different from each other. Components that are similar to those of the control circuit 400 according to the reference example are denoted by the same reference numerals and their description will be incorporated by reference, for conciseness.

As illustrated in FIGS. 1A and 1B, the control circuit 100 according to the present embodiment is a control circuit for controlling the load circuit 200 including a load element 2 such as a coil or a motor, and may be referred to as a drive circuit that drives the load element 2. The control circuit 100 includes a semiconductor element 1 having one H-bridge drive circuit 9 integrated therein. The control circuit 100 also includes output lines 3 and 4 that connect the semiconductor element 1 and the load element 2 to output driving current to the load element 2, and power supply lines 5 and 6 that connect the semiconductor element 1 and a DC power source B to supply power to the semiconductor element 1.

In FIGS. 1A and 1B, the semiconductor element 1 surrounded by a broken line includes transistors 10, 11, 12, and 13 as switching elements, and output lines 3 and 4. The transistors 10, 11, 12, and 13 are switching elements that open and close current to the load element 2. The transistors 10, 11, 12, and 13 are all N-channel MOSFETs. Transistors 10, 11, 12, and 13 may be all P-channel MOSFETs. In the transistors 10, 11, 12, and 13, N-channel MOSFETs and P-channel MOSFETs may be mixed, such as a case where the high-side is a P-channel MOSFET and the low-side is an N-channel MOSFET. The present disclosure is not so limited and, for example, the switching element may be provided as an insulated gate bipolar transistor (IGBT).

In the semiconductor element 1, the source of the transistor 10 and the drain of the transistor 11 are connected via the wiring W1. In addition, the source of the transistor 12 and the drain of the transistor 13 are connected via the wiring W2. In addition, the drain of the transistor 10 and the drain of the transistor 12 are connected via the wiring W3. In addition, the source of the transistor 11 and the source of the transistor 13 are connected via the wiring W4. One end of the output line 3 is connected to the wiring W1 between the source of the transistor 10 and the drain of the transistor 11. The other end of the output line 3 is connected to one terminal of the load element 2. One end of the output line 4 is connected to the wiring W2 between the source of the transistor 12 and the drain of the transistor 13. The other end of the output line 4 is connected to the other terminal of the load element 2. The power supply line 5, which is connected to the positive electrode of the DC power source B such as a secondary battery, is connected to the wiring W3 between the drain of the transistor 10 and the drain of the transistor 12. The power supply line 6, which is connected to the negative electrode of the DC power source B, is connected to the wiring W4 between the source of the transistor 11 and the source of the transistor 13. The power supply line 5 is a power supply line that is supplied with a power supply potential by the DC power source B. The power supply line 6 is a ground line that is supplied with a ground potential. The one terminal and the other terminal of the load element 2 are a first terminal and a second terminal of the load circuit 200, respectively.

In this manner, the H-bridge drive circuit 9 is configured by the transistors 10, 11, 12, and 13 serving as four switching elements in the semiconductor element 1. In the H-bridge drive circuit 9, the transistor 10 is connected between the output line 3 and the power supply line 5. The transistor 11 is connected between the output line 3 and the power supply line 6, and is connected in series with the transistor 10. The transistor 12 is connected between the output line 4 and the power supply line 5, and is connected in series with the transistor 13. The transistor 13 is connected between an output line 4 and the power supply line 6.

A control unit that controls ON/OFF of the transistors 10, 11, 12, and 13 is connected to the gates of the transistors 10, 11, 12, and 13. The control unit includes a microprocessor that generates voltage signals as control signals such as PWM signals for switching ON/OFF of the gates, and a gate driver IC that converts the voltages of the control signals from the microprocessor and applies them to the gates. The load element 2, which is an electronic component such as a coil, a motor, or the like, is driven by predetermined current by switching ON/OFF of the transistors 10, 11, 12, and 13 by the control signals such as PWM signals.

In the control circuit 100 according to the present embodiment, a capacitor 7 is connected between the output line 3 and the power supply line 5. The capacitor 7 is provided on a wiring W5 that connects the output line 3 and the power supply line 5. In addition, a capacitor 8 is connected between the output line 4 and the power supply line 6. The capacitor 8 is provided on a wiring W6 that connects the output line 4 and the power supply line 6. One or both of the capacitor 7 and the capacitor 8 may have a capacitance greater than 100 pF so that the impedance becomes low at the frequency component of the radiated noise to be reduced.

FIG. 1A illustrates a case where driving current for driving the load element 2 flows through the output line 3 of the semiconductor element 1. In this case, the transistor 10 and the transistor 13 are turned ON, and the transistor 11 and the transistor 12 are turned OFF. In this state, the driving current flows from the power supply line 5 to the load element 2 through the output line 3 via the transistor 10. High-frequency current generated in the transistor 10, which is switched at a high speed, does not flow to the load element 2 through the output line 3, but returns to the transistor 10 through the capacitor 7 having a low impedance, as illustrated by the dotted line. Thus, high-frequency radiated noise does not occur from the output line 3 and the load element 2.

FIG. 1B illustrates a case where the driving current for driving the load element 2 flows through the output line 4 of the semiconductor element 1. In this case, the transistor 11 and the transistor 12 are turned ON, and the transistor 10 and the transistor 13 are turned OFF. In this state, the driving current flows from the power supply line 5 to the load element 2 through the output line 4 via the transistor 12. High-frequency current generated in the transistor 12, which is switched at high speed, does not flow to the load element 2 from the output line 4, but flows to the power supply line 6 via the capacitor 8 having a low impedance, as illustrated by the dotted line. Thus, high-frequency radiated noise does not occur from the output line 4 and the load element 2.

Thus, the control circuit 100 according to the present embodiment can reduce the radiated noise generated from the output lines 3 and 4 and the load element 2. One or both of the wiring W5 provided with the capacitor 7 and the wiring W6 provided with the capacitor 8 may be as short as possible. The shorter the wiring W5 and the wiring W6, the shorter the path through which the high-frequency current flows, which can further improve the effect of reducing the radiated noise.

The control circuit 100 according to the present embodiment may include a circuit substrate 20 on which the above-described semiconductor element 1 is mounted. Here, the wiring layout of the circuit substrate 20 in the control circuit 100 according to the present embodiment will be described with reference to FIGS. 2A and 2B. FIG. 2A is a sectional view illustrating the wiring layout of the circuit substrate 20 on which the semiconductor element 1 is mounted in the control circuit 100 according to the present embodiment. FIG. 2B is an overhead view illustrating the wiring layout of the circuit substrate 20 on which a semiconductor element 1 is mounted in a control circuit 100 according to the present embodiment. FIG. 2B is an overhead view as seen from the side of the circuit substrate 20 on which the semiconductor element 1 is mounted.

The circuit substrate 20 is a printed wiring board, a printed circuit board, or the like. As illustrated in FIGS. 2A and 2B, a plurality of electrodes 25 for mounting the semiconductor element 1 by solder are provided on one surface 20a of the surfaces 20a and 20b of the circuit substrate 20, which are opposite to each other. The electrodes 25 are, for example, pads. The plurality of electrodes 25 includes output electrodes 21 and 22 and power supply electrodes 23 and 24. The plurality of electrodes 25 are, for example, arranged in a lattice pattern or a grid pattern. The circuit substrate 20 is provided with the output lines 3 and 4 and the power supply lines 5 and 6. The output electrode 21 is included in the output line 3. The output electrode 22 is included in the output line 4. The power supply electrode 23 is included in the power supply line 5. The power supply electrode 24 is included in the power supply line 6.

The semiconductor element 1 is joined to the plurality of electrodes 25 including the output electrodes 21 and 22 and the power supply electrodes 23 and 24 by solder balls 26, which are joining bodies, and is mounted on the one surface 20a of the circuit substrate 20. The semiconductor element 1 includes a first output terminal included in the output line 3, a second output terminal included in the output line 4, a first power terminal included in the power supply line 5, and a second power terminal included in the power supply line 6. The first output terminal is connected to the output electrode 21 by the solder ball 26. The second output terminal is connected to the output electrode 22 by the solder ball 26. The first power terminal is connected to the power supply electrode 23 by the solder ball 26. The second power terminal is connected to the power supply electrode 24 by the solder ball 26. The distance between the first power terminal and the second power terminal is greater than the distance between the first output terminal and the second output terminal.

The output electrode 21 and the output electrode 22 are arranged adjacent to each other to reduce the wiring loop that includes the output lines 3 and 4, which generate radiated noise that is an electromagnetic noise. No other electrode 25 is provided between the output electrode 21 and the output electrode 22.

The output electrode 21 included in the output line 3 is arranged adjacent to the power supply electrode 23 included in the power supply line 5. No other electrode 25 is provided between the output electrode 21 and the power supply electrode 23. The output electrode 21 is connected to one terminal 71 of the capacitor 7 via a wiring W5-1. The power supply electrode 23 is connected to the other terminal 72 of the capacitor 7 via a wiring W5-2. The wirings W5-1 and W5-2 constitute the above-described wiring W5 and are provided on the circuit substrate 20. The capacitor 7 is arranged and mounted on the surface 20a of the circuit substrate 20 on which the semiconductor element 1 is mounted.

The output electrode 22 included in the output line 4 is arranged adjacent to the power supply electrode 24 included in the power supply line 6. No other electrode 25 is provided between the output electrode 22 and the power supply electrode 24. The output electrode 22 is connected to one terminal 81 of the capacitor 8 via a wiring W6-1. The power supply electrode 24 is connected to the other terminal 82 of the capacitor 8 via a wiring W6-2. The wirings W6-1 and W6-2 constitute the above-described wiring W6 and are provided on the circuit substrate 20. The capacitor 8 is arranged and mounted on the surface 20a of the circuit substrate 20 on which the semiconductor element 1 is mounted.

The capacitor 7 and the capacitor 8 are arranged and mounted on the side of the semiconductor element 1 so as to be adjacent to the semiconductor element 1 on the surface 20a of the circuit substrate 20 where the semiconductor element 1 is mounted.

Due to the structure in which the output electrodes 21 and 22 and the power supply electrodes 23 and 24 are arranged as described above, the wiring W5 for connecting the capacitor 7 and the wiring W6 for connecting the capacitor 8 can be made shorter. Since the wirings W5 and W6, through which high-frequency current may flow, can be made shorter, it is possible to further enhance the effect of reducing radiated noise.

As described above, according to this embodiment, high-frequency current is suppressed at the output of the semiconductor element 1 and radiated noise is reduced.

### Second Embodiment

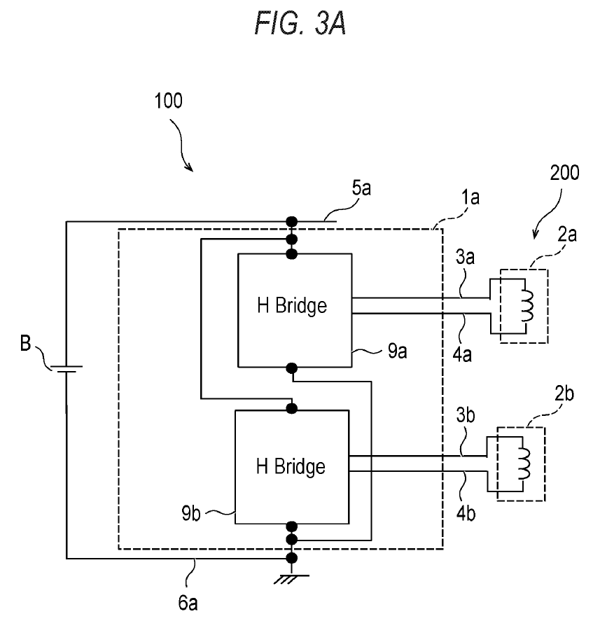

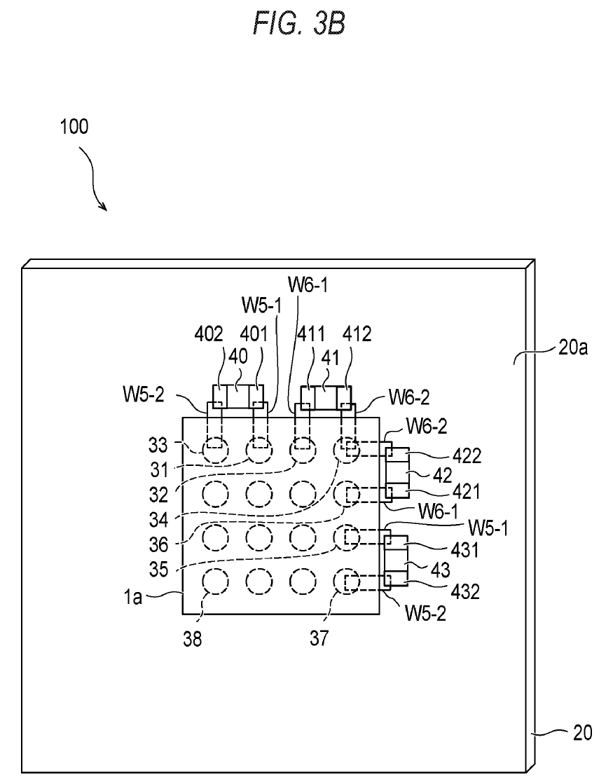

A control circuit according to a second embodiment of the present disclosure will be described with reference to FIGS. 3A and 3B. FIG. 3A is a circuit diagram illustrating the control circuit according to the present embodiment. FIG. 3B is an overhead view illustrating the wiring layout of a circuit substrate in the control circuit according to the present embodiment. Components similar to those in the first embodiment will be denoted by the same reference numerals and their descriptions will be incorporated by reference, for conciseness.

As illustrated in FIG. 3A, the control circuit 100 according to the present embodiment includes a semiconductor element 1a having two H-bridge driving circuits 9a and 9b integrated therein. The semiconductor element 1a is a driver IC. The H-bridge driving circuit 9a drives the load element 2a via output lines 3a and 4a. The H-bridge driving circuit 9b drives the load element 2b via output lines 3b and 4b. Like the load element 2 of the first embodiment, the load elements 2a and 2b are coils, motors, or the like, and are included in the load circuit 200. More specifically, the load elements 2a and 2b are, for example, a motor for X-direction driving and a motor for Y-direction driving in an image stabilization motor unit or a shake correction motor unit.

The H-bridge driving circuits 9a and 9b each have the same configuration as that of the H-bridge driving circuit 9 of the first embodiment. The H-bridge driving circuits 9a and 9b are connected in parallel with each other. In the H-bridge driving circuit 9a, one end of the output line 3a is connected to the wiring W1 between the source of the transistor 10 and the drain of the transistor 11. The other end of the output line 3a is connected to one terminal of the load element 2a. In addition, in the H-bridge driving circuit 9a, one end of the output line 4a is connected to the wiring W2 between the source of the transistor 12 and the drain of the transistor 13. The other end of the output line 4a is connected to the other terminal of the load element 2a. In the H-bridge driving circuit 9b, one end of the output line 3b is connected to the wiring W1 between the source of the transistor 10 and the drain of the transistor 11. The other end of the output line 3b is connected to one terminal of the load element 2b. In addition, in the H-bridge driving circuit 9b, one end of the output line 4b is connected to the wiring W2 between the source of the transistor 12 and the drain of the transistor 13. The other end of the output line 4b is connected to the other terminal of the load element 2b. In each of the H-bridge driving circuits 9a and 9b, a power supply line 5a, which is connected to the positive electrode of the DC power source B such as a secondary battery, is connected to the wiring W3 between the drain of the transistor 10 and the drain of the transistor 12. A power supply line 6a, which is connected to the negative electrode of the DC power source B, is connected to the wiring W4 between the source of the transistor 11 and the source of the transistor 13. The power supply line 5a is a power supply line that is supplied with a power supply potential by the DC power source B. The power supply line 6a is a ground line that is supplied with a ground potential. The one terminal and the other terminal of the load element 2a are a first terminal and a second terminal of the load circuit 200, respectively. The one terminal and the other terminal of the load element 2b are a third terminal and a fourth terminal of the load circuit 200, respectively.

The control circuit 100 according to the present embodiment may have a circuit substrate 20 on which the semiconductor element 1a is mounted. Here, the wiring layout of the circuit substrate 20 in the control circuit 100 according to the present embodiment will be described with reference to FIG. 3B.

As illustrated in FIG. 3B, a plurality of electrodes 38 for mounting the semiconductor element 1a by solder are provided on one surface 20a of the surfaces 20a and 20b of the circuit substrate 20, which are opposite to each other. The electrodes 38 are, for example, pads. The plurality of electrodes 38 include output electrodes 31, 32, 35, and 36 and power supply electrodes 33, 34, and 37. The plurality of electrodes 38 are, for example, arranged in a lattice pattern or a grid pattern. The circuit substrate 20 is provided with the output lines 3a, 3b, 4a and 4b and the power supply lines 5a and 6a. The output electrode 31 is included in the output line 3a. The output electrode 32 is included in the output line 4a. The power supply electrode 33 is included in the power supply line 5a. The power supply electrode 34 is included in the power supply line 6a. The output electrode 35 is included in the output line 3b. The output electrode 36 is included in the output line 4b. The power supply electrode 37 is included in the power supply line 5a. The semiconductor element 1a is joined to the plurality of electrodes 38 including the output electrodes 31, 32, 35, and 36 and the power supply electrodes 33, 34, and 37 by solder balls, which are joining bodies, and is mounted on the one surface 20a of the circuit substrate 20.

The output electrode 31 and the output electrode 32 are arranged adjacent to each other to reduce the wiring loop that includes the output lines 3a and 4a, which generate radiated noise that is electromagnetic noise. No other electrode 38 is provided between the output electrode 31 and the output electrode 32.

The output electrode 35 and the output electrode 36 are arranged adjacent to each other to reduce the wiring loop that includes the output lines 3b and 4b, which generate radiated noise that is electromagnetic noise. No other electrode 38 is provided between the output electrode 35 and the output electrode 36.

The output electrode 31 included in the output line 3a is arranged adjacent to the power supply electrode 33 included in the power supply line 5a. No other electrode 38 is provided between the output electrode 31 and the power supply electrode 33. The output electrode 31 is connected to one terminal 401 of the capacitor 40 via a wiring W5-1 constituting the wiring W5 as in the first embodiment. The power supply electrode 33 is connected to the other terminal 402 of the capacitor 40 via a wiring W5-2 constituting the wiring W5 as in the first embodiment. The capacitor 40 is a capacitor similar to the capacitor 7 of the first embodiment, and is arranged and mounted on the surface 20a of the circuit substrate 20 on which the semiconductor element 1a is mounted.

The output electrode 32 included in the output line 4a is arranged adjacent to the power supply electrode 34 included in the power supply line 6a. No other electrode 38 is provided between the output electrode 32 and the power supply electrode 34. The output electrode 32 is connected to one terminal 411 of the capacitor 41 via a wiring W6-1 constituting the wiring W6 as in the first embodiment. The power supply electrode 34 is connected to the other terminal 412 of the capacitor 41 via a wiring W6-2 constituting the wiring W6 as in the first embodiment. The capacitor 41 is a capacitor similar to the capacitor 8 of the first embodiment, and is arranged and mounted on the surface 20a of the circuit substrate 20 on which the semiconductor element 1a is mounted.

The output electrode 35 included in the output line 3b is arranged adjacent to the power supply electrode 37 included in the power supply line 5a. No other electrode 38 is provided between the output electrode 35 and the power supply electrode 37. The output electrode 35 is connected to one terminal 431 of the capacitor 43 via a wiring W5-1 constituting the wiring W5 as in the first embodiment. The power supply electrode 37 is connected to the other terminal 432 of the capacitor 43 via a wiring W5-2 constituting the wiring W5 as in the first embodiment. The capacitor 43 is a capacitor similar to the capacitor 7 of the first embodiment, and is arranged and mounted on a surface 20a of the circuit substrate 20 on which the semiconductor element 1a is mounted.

The output electrode 36 included in the output line 4b is arranged adjacent to the power supply electrode 34 included in the power supply line 6a. No other electrode 38 is provided between the output electrode 36 and the power supply electrode 34. The output electrode 36 is connected to one terminal 421 of the capacitor 42 via a wiring W6-1 constituting the wiring W6 as in the first embodiment. The power supply electrode 34 is connected to the other terminal 422 of the capacitor 42 via a wiring W6-2 constituting the wiring W6 as in the first embodiment. The capacitor 42 is a capacitor similar to the capacitor 8 of the first embodiment, and is arranged and mounted on the surface 20a of the circuit substrate 20 on which the semiconductor element 1a is mounted.

The capacitors 40, 41, 42, and 43 are arranged and mounted on the side of the semiconductor element 1a so as to be adjacent to the semiconductor element 1a on the surface 20a of the circuit substrate 20 where the semiconductor element 1 is mounted. Some or all of the capacitors 40,41, 42, and 43 may have a capacitance greater than 100 pF, so that the impedance becomes low at the frequency component of the radiated noise to be reduced.

As for the H-bridge drive circuit 9a, as in the first embodiment, the capacitors 40 and 41 prevent high-frequency radiated noise from occurring from the output lines 3a and 4a and the load element 2a. Similarly, as for the H-bridge drive circuit 9b, as in the first embodiment, the capacitors 43 and 42 prevent high-frequency radiated noise from occurring from the output lines 3b and 4b and the load element 2b. Thus, in the control circuit 100 according to the present embodiment, it is possible to reduce radiated noise that occurs from the output lines 3a and 4a, the output lines 3b and 4b, the load element 2a, and the load element 2b.

In addition, the wiring W5 for connecting the capacitor 40 can be made shorter by the structure in which the output electrodes 31, 32, 35 and 36 and the power supply electrodes 33, 34 and 37 are arranged as described above. In addition, the wiring W6 for connecting the capacitor 41 can be made shorter. In addition, the wiring W6 for connecting the capacitor 42 can be made shorter. In addition, the wiring W5 for connecting the capacitor 43 can be made shorter. Thus, radiated noise is further reduced.

As described above, according to the present embodiment, it is possible to suppress high-frequency current at the output of the semiconductor element 1a, which has the two H-bridge drive circuits 9a and 9b integrated therein, and realize a higher effect of reducing radiated noise.

Although the case in which the semiconductor element 1a has the two H-bridge driving circuits 9a and 9b integrated therein has been described above, the semiconductor element 1a may have three or more H-bridge driving circuits integrated therein. Even in this case, a capacitor can be similarly connected for each H-bridge driving circuit.

### Third Embodiment

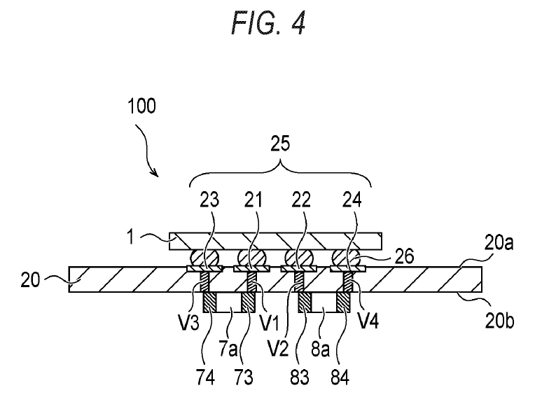

A control circuit according to a third embodiment of the present disclosure will be described with reference to FIG. 4. FIG. 4 is a cross-sectional view illustrating the wiring layout of a circuit substrate in the control circuit according to the third embodiment. Components similar to those in the above first and second embodiments will be denoted by the same reference numerals and their descriptions will be incorporated by reference, for conciseness.

The basic configuration of the control circuit 100 according to the present embodiment is the same as that of the control circuit 100 according to the first embodiment. In the control circuit 100 according to the present embodiment, in the circuit substrate 20, capacitors 7a and 8a, similar to capacitors 7 and 8 according to the first embodiment, are mounted on the surface 20b opposite to the surface 20a on which the semiconductor element 1 is mounted. In this respect, the control circuit 100 according to the present embodiment is different from the control circuit 100 according to the first embodiment. The capacitors 7a and 8a are similar to the capacitors 7 and 8 according to the first embodiment.

As illustrated in FIG. 4, in the control circuit 100 according to the present embodiment, the semiconductor element 1 is mounted on the one surface 20a of the circuit substrate 20, and the capacitors 7a and 8a are mounted on the other surface 20b of the circuit substrate 20. The surface 20b of the circuit substrate 20 on which the capacitors 7a and 8a are mounted is an opposite surface to the surface 20a of the circuit substrate 20 on which the semiconductor element 1 is mounted.

The plurality of electrodes 25, which are a plurality of electrodes for mounting the semiconductor element 1 by solder, are provided on one surface 20a of the surfaces 20a and 20b of the circuit substrate 20, which are opposite to each other. The plurality of electrodes 25 include the output electrodes 21 and 22 and the power supply electrodes 23 and 24. The plurality of electrodes 25 are, for example, arranged in a lattice pattern or a grid pattern. The circuit substrate 20 is provided with the output lines 3 and 4 and the power supply lines 5 and 6. The output electrode 21 is included in the output line 3. The output electrode 22 is included in the output line 4. The power supply electrode 23 is included in the power supply line 5. The power supply electrode 24 is included in the power supply line 6. The semiconductor element 1 is joined to the plurality of electrodes 25 including the output electrodes 21 and 22 and the power supply electrodes 23 and 24 by the solder balls 26, which are joining bodies, and is mounted on the one surface 20a of the circuit substrate 20.

Vias V1, V2, V3, and V4 connected to output electrodes 21 and 22 and power supply electrodes 23 and 24, respectively, are provided inside the circuit substrate 20. One end of the vias V1, V2, V3, and V4 is connected to the output electrodes 21 and 22 and the power supply electrodes 23 and 24, respectively. The other end of the vias V1, V2, V3, and V4 reaches the other surface 20b of the circuit substrate 20, respectively.

The output electrode 21 and the output electrode 22 are arranged adjacent to each other to reduce the wiring loop including the output lines 3 and 4, which generate radiated noise that is electromagnetic noise. No other electrode 25 is provided between the output electrode 21 and the output electrode 22.

The output electrode 21 included in the output line 3 is arranged adjacent to the power supply electrode 23 included in the power supply line 5. No other electrode 25 is provided between the output electrode 21 and the power supply electrode 23. The output electrode 21 is connected to one terminal 73 of the capacitor 7a via the via V1. The power supply electrode 23 is connected to the other terminal 74 of the capacitor 7a via the via V3. The vias V1 and V3 constitute the wiring W5 described in the first embodiment. The capacitor 7a is arranged and mounted on the surface 20b of the circuit substrate 20 opposite to the surface 20a on which the semiconductor element 1 is mounted.

The output electrode 22 included in the output line 4 is arranged adjacent to the power supply electrode 24 included in the power supply line 6. No other electrode 25 is provided between the output electrode 22 and the power supply electrode 24. The output electrode 22 is connected to one terminal 83 of the capacitor 8a via the via V2. The power supply electrode 24 is connected to the other terminal 84 of the capacitor 8a via the via V4. The vias V2 and V4 constitute the wiring W6 described in the first embodiment. The capacitor 8a is arranged and mounted on the surface 20b of the circuit substrate 20 opposite to the surface 20a on which the semiconductor element 1 is mounted.

In this way, on the surface 20b of the circuit substrate 20 opposite to the surface 20a on which the semiconductor element 1 is mounted, the capacitor 7a is arranged and mounted immediately under the output electrode 21 and the power supply electrode 23. On the opposite surface 20b, the capacitor 8a is arranged and mounted immediately under the output electrode 22 and the power supply electrode 24. The capacitors 7a and 8a are arranged and mounted on the opposite surface 20b of the circuit substrate 20 so as to overlap with the semiconductor element 1 in a plan view viewed in the normal direction of the surface 20a on which the semiconductor element 1 is mounted.

With the connection structure using the vias V1, V2, V3, and V4 as described above, the wiring W5 for connecting the capacitor 7a and the wiring W6 for connecting the capacitor 8a can be made shorter. Since the wirings W5 and W6, through which high-frequency current may flow, can be made shorter, it is possible to further reduce radiated noise.

The capacitors 7a and 8a can also be mounted on the surface 20b of the circuit substrate 20 opposite to the surface 20a on which the semiconductor element 1 is mounted.

In the control circuit 100 according to a second embodiment having the semiconductor element 1a having the two H-bridge driving circuits 9a and 9b integrated therein, the capacitors 40, 41, 42, and 43 can also be mounted, as in the present embodiment.

### Fourth Embodiment

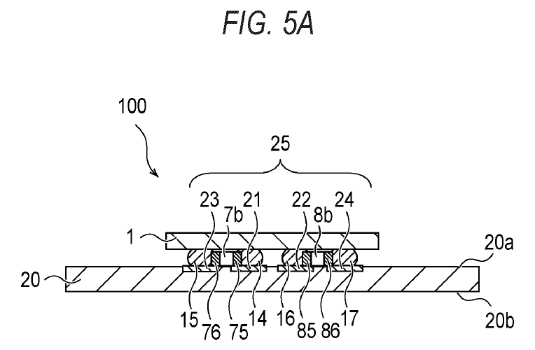

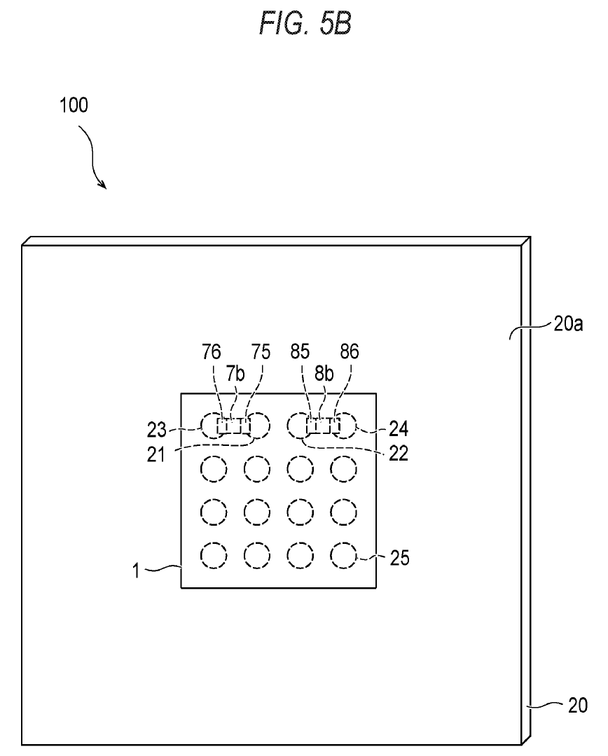

A control circuit according to a fourth embodiment of the present disclosure will be described with reference to FIGS. 5A and 5B. FIG. 5A is a cross-sectional view illustrating the wiring layout of a circuit substrate in the control circuit according to the present embodiment. FIG. 5B is an overhead view illustrating the wiring layout of the circuit substrate in the control circuit according to the present embodiment. Components similar to those in the above first to third embodiments will be denoted by the same reference numerals and their descriptions will be incorporated by reference, for conciseness.

The basic configuration of the control circuit 100 according to the present embodiment is the same as the configuration of the control circuit 100 according to the first embodiment. The control circuit 100 according to the present embodiment is different from the control circuit 100 according to the first embodiment in that capacitors 7b and 8b are mounted on the surface 20a of the circuit substrate 20 on which the semiconductor element 1 is mounted so as to make the capacitors 7b and 8b positioned between the semiconductor element 1 and the circuit substrate 20. The capacitors 7b and 8b are the same as the capacitors 7 and 8 according to the first embodiment.

As illustrated in FIGS. 5A and 5B, the plurality of electrodes 25 for mounting the semiconductor element 1 by solder are provided on one surface 20a of the surfaces 20a and 20b of the circuit substrate 20, which are opposite to each other. The plurality of electrodes 25 include the output electrodes 21 and 22 and the power supply electrodes 23 and 24. The plurality of electrodes 25 are, for example, arranged in a lattice pattern or a grid pattern. The circuit substrate 20 is provided with the output lines 3 and 4 and the power supply lines 5 and 6. The output electrode 21 is included in the output line 3. The output electrode 21 is connected to the semiconductor element 1 by a solder ball 14, which is a joining body. The output electrode 22 is included in the output line 4. The output electrode 22 is connected to the semiconductor element 1 by a solder ball 16, which is a joining body. The power supply electrode 23 is included in the power supply line 5. The power supply electrode 23 is connected to the semiconductor element 1 by a solder ball 15, which is a joining body. The power supply electrode 24 is included in the power supply line 6. The power supply electrode 24 is connected to the semiconductor element 1 by a solder ball 17, which is a joining body.

The output electrode 21 and the output electrode 22 are arranged adjacent to each other to reduce the wiring loop including the output lines 3 and 4, which generate radiated noise that is electromagnetic noise. No other electrode 25 is provided between the output electrode 21 and the output electrode 22.

The output electrode 21 included in the output line 3 is arranged adjacent to the power supply electrode 23 included in the power supply line 5. No other electrode 25 is provided between the output electrode 21 and the power supply electrode 23. The output electrode 21 is connected to one terminal 75 of the capacitor 7b by the solder ball 14. The power supply electrode 23 is connected to the other terminal 76 of the capacitor 7b by the solder ball 15. The solder balls 14 and 15 constitute the wiring W5 described in the first embodiment. The capacitor 7b is arranged and mounted on the surface 20a of the circuit substrate 20 on which the semiconductor element 1 is mounted so as to be positioned between the semiconductor element 1 and the circuit substrate 20.

The output electrode 22 included in the output line 4 is arranged adjacent to the power supply electrode 24 included in the power supply line 6. No other electrode 25 is provided between the output electrode 22 and the power supply electrode 24. The output electrode 22 is connected to one terminal 85 of the capacitor 8b by the solder ball 16. The power supply electrode 24 is connected to the other terminal 86 of the capacitor 8b by the solder ball 17. The capacitor 8b is mounted on the surface 20a of the circuit substrate 20 on which the semiconductor element 1 is mounted so as to be positioned between the semiconductor element 1 and the circuit substrate 20.

In the present embodiment, the capacitors 7b and 8b are positioned between the semiconductor element 1 and the circuit substrate 20 as described above. Thus, the capacitors that can be used as the capacitors 7b and 8b are limited to those whose length in the long side direction along the direction between the terminals is shorter than the distance between the electrodes 25, and whose length in the height direction between the semiconductor element 1 and the circuit substrate 20 shorter than the height of the solder ball.

Due to the connection structure using the solder balls 14, 15, 16, and 17, which are joining bodies, as described above, the wiring W5 for connecting the capacitor 7b and the wiring W6 for connecting the capacitor 8b can be made shorter. Since the wiring W5 and W6, through which high-frequency current may flow, can be made shorter, it is possible to further reduce radiated noise.

The capacitors 7b and 8b may be mounted on the surface 20a of the circuit substrate 20 on which the semiconductor element 1 is mounted so as to be positioned between the semiconductor element 1 and the circuit substrate 20. Some radiated noise occurs from the wiring arranged between the semiconductor element 1 that drives the load element 2 and the load element 2. In the present embodiment, since the capacitors 7b and 8b are positioned between the semiconductor element 1 and the circuit substrate 20, the radiated noise that occurs from such wiring can be more effectively reduced.

In the control circuit 100 according to the second embodiment, which includes the semiconductor element 1a having the two H-bridge driving circuits 9a and 9b incorporated therein, the capacitors 40, 41, 42, and 43 can be mounted similar to the present embodiment.

### Example

A control circuit corresponding to the control circuit 100 according to the second embodiment, which included the semiconductor element 1a having the two H-bridge driving circuits 9a and 9b incorporated therein, was used in an image stabilization motor unit of a lens product, and the radiated noise from the control circuit was measured. The measurement of the radiated noise was carried out in three cases of “no countermeasure,” “capacitor insertion (between output and power supply),” and “capacitor insertion (between output and GND).” In the case of “no countermeasure,” none of the capacitors 40, 41, 42 and 43 was provided in the control circuit 100, so that no countermeasure against radiated noise was implemented. In the case of “capacitor insertion (between output and power supply),” the capacitor 40 was connected between the output line 3a and the power supply line 5a, the capacitor 43 was connected between the output line 3b and the power supply line 5a, and the capacitors 41 and 42 were not provided. In the case of “capacitor insertion (between output and GND),” the capacitor 41 was connected between the output line 4a and the power supply line 6a, the capacitor 42 was connected between the output line 4b and the power supply line 6a, and the capacitors 40 and 43 were not provided.

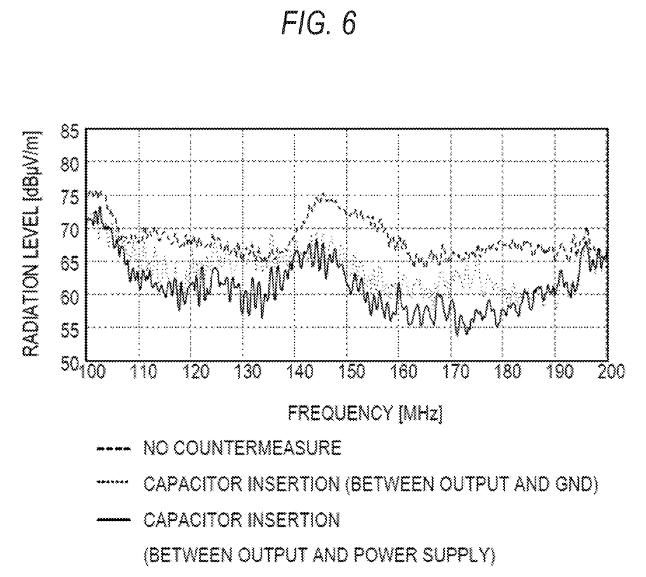

FIG. 6 is a graph showing the radiated noise measured in the above three cases. The horizontal axis of the graph indicates the frequency from 100 [MHz] to 200 [MHz], and the vertical axis indicates the radiation level [dBμV/m] of the radiated noise.

The results shown in FIG. 6 reveal that the radiated noise was reduced in both cases of “capacitor insertion (between output and power supply)” and “capacitor insertion (between output and GND)”, compared with the case of “no countermeasure.”

Here, in the measurement of the radiated noise, capacitors with a capacitance of 1000 pF having a self-resonance frequency near the frequency components where the radiated noise should be reduced were used for the capacitors 40, 41, 42 and 43. The inductance component of these capacitors increased in proportion to the length of the wiring used to connect the capacitors. When the impedance of the capacitor increased, the high-frequency current hardly flowed to the capacitor, and the radiated noise was weakened. In the present example, the wirings for connecting the capacitors 40 and 43 in the case of “capacitor insertion (between output and power supply)” was shorter than the wirings for connecting the capacitors 41 and 42 in the case of “capacitor insertion (between output and GND).” Thus, the reduction effect of radiated noise was higher in the case of “capacitor insertion (between output and power supply)” than in the case of “capacitor insertion (between output and GND).”

From the above results, it is understood that the radiated noise is reduced both when a capacitor is connected between the output line and the power supply and when a capacitor is connected between the output line and the ground. When connecting a capacitor between the plurality of output electrodes and the same power supply electrode, it is difficult to make all the capacitors adjacent to the semiconductor element, and the wirings for connecting the capacitors become long. By connecting the capacitor between the output electrode and the power supply electrode adjacent thereto, the degree of freedom of layout is increased, and radiated noise is reduced.

### Fifth Embodiment

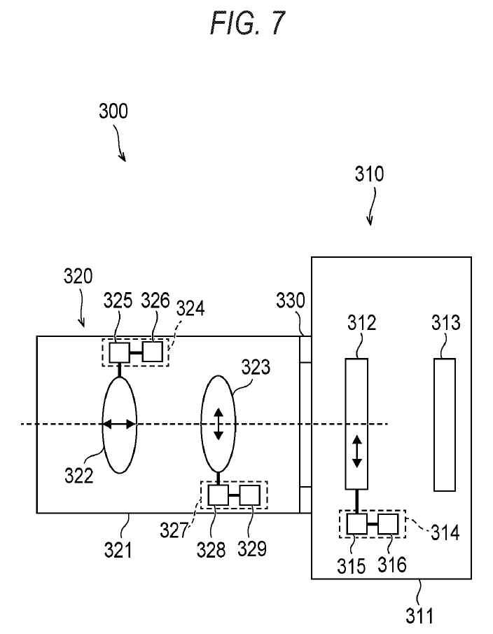

Equipment according to a fifth embodiment of the present disclosure will be described with reference to FIG. 7. FIG. 7 is a schematic diagram illustrating a camera system 300 including a camera body 310 and an interchangeable lens 320 as an example of the equipment according to the present embodiment.

The camera system 300 according to the present embodiment is a digital camera such as a digital still camera, a digital video camera, or the like, and is a digital single-lens reflex camera in the example illustrated in FIG. 7. The camera system 300 includes a camera body 310 as electronic equipment, and an interchangeable lens 320 as optical equipment attachable to and detachable from the camera body 310. The interchangeable lens 320 is attached to the camera body 310 via a mount 330.

The camera body 310 includes a housing 311, an imaging element 312 that captures an image of an object, and a display element 313 that displays the image captured by the imaging element 312. The camera body 310 also includes an image stabilization module 314. The imaging element 312, the display element 313, and the image stabilization module 314 are housed in the housing 311.

The image stabilization module 314 is an electrical apparatus that reduces image blur or camera shake in the image. The image stabilization module 314 includes a load circuit 315 including a voice coil motor, and a control circuit 316 that controls the load circuit 315. The voice coil motor included in the load circuit 315 moves the imaging element 312 as a movable element in a direction orthogonal to or crossing the optical axis of the camera system 300, for example. As the voice coil motor, a drive coil discussed in Japanese Patent Laid-Open No. 2020-140103, or the like may be used. The control circuit 316 controls the load circuit 315 including the voice coil motor by, for example, PWM control. The voice coil motor included in the load circuit 315 corresponds to the load element 2 or the load elements 2a and 2b. The load circuit 315 corresponds to the load circuit 200. The control circuit 316 is constituted by the control circuit 100 according to any of the first to fourth embodiments. The image stabilization module 314 reduces image blur or camera shake by moving the imaging element 312.

The interchangeable lens 320 includes a lens barrel 321 attachable to and detachable from the housing 311, and optical elements 322 and 323 which are lenses. The interchangeable lens 320 includes an autofocus (AF) module 324 and an image stabilization module 327. The optical elements 322 and 323, the AF module 324 and the image stabilization module 327 are housed in the lens barrel 321.

The AF module 324 is an electrical apparatus that automatically adjusts the focus of the camera system 300. The AF module 324 includes a load circuit 325 including a stepping motor and a control circuit 326 that controls the load circuit 325. The stepping motor included in the load circuit 325 moves the optical element 322 for AF as a movable element in a direction parallel to the optical axis of the camera system 300, for example. As the stepping motor, a stepping motor discussed in Japanese Patent Laid-Open No. 2010-154687, or the like may be used. The control circuit 326 controls the load circuit 325 including the stepping motor by, for example, PWM control. The stepping motor included in the load circuit 325 corresponds to the load element 2 or the load elements 2a and 2b. The load circuit 325 corresponds to the load circuit 200. The control circuit 326 is constituted by the control circuit 100 according to any of the first to fourth embodiments. The module 324 for AF adjusts the focus by moving the optical element 322.

The image stabilization module 327 is an electrical apparatus that reduces image blur or camera shake in the image. The image stabilization module 327 includes a load circuit 328 including a voice coil motor, and a control circuit 329 that controls the load circuit 328. The voice coil motor included in the load circuit 328 moves the optical element 323 for image stabilization as a movable element in a direction orthogonal to or crossing the optical axis of the camera system 300, for example. As the voice coil motor, a voice coil type motor discussed in Japanese Patent Laid-Open No. 2015-11277, or the like may be used. The control circuit 329 controls the load circuit 328 including the voice coil motor by, for example, PWM control. The voice coil motor included in the load circuit 328 corresponds to the load element 2 or the load elements 2a and 2b. The load circuit 328 corresponds to the load circuit 200. The control circuit 329 is constituted by the control circuit 100 according to any of the first to fourth embodiments. The image stabilization module 327 reduces image blur or camera shake by moving the optical element 323.

As the PWM control in the control circuits 316, 326, and 329, PWM control discussed in Japanese Patent Laid-Open No. 2020-140103, Japanese Patent Laid-Open No. 2024-056449, or the like may be used.

As described in the present embodiment, the control circuit 100 according to any of the first to fourth embodiments controls a load circuit including a load element such as a voice coil motor or a stepping motor in equipment such as the camera body 310, the interchangeable lens 320, or the like to drive the load element.

The electrical apparatus provided with the control circuit 100 and the load circuit 200 may be mounted not only in a camera system but also in equipment that constitutes various systems. For example, the equipment may be information equipment such as a smartphone or a personal computer, or communication equipment such as a modem or a router. Alternatively, the equipment may be office equipment or printing equipment such as a printer, a copier or a scanner, medical equipment such as an X-ray photographing apparatus, an endoscope, or the like, industrial equipment such as a robot, a semiconductor manufacturing apparatus, or the like, or transportation equipment such as a vehicle, an airplane, a ship, or the like. When the control circuit is provided in a limited space in a housing, improvement of noise characteristics and consequently improvement of reliability of the electronic equipment can be realized. The electronic equipment may be provided with another electrical apparatus in addition to the electrical apparatus provided with the control circuit. The other electrical apparatus may be various and may be an electro-optical apparatus such as an image sensor, a display, or the like, a storage apparatus such as a memory or the like, an arithmetic apparatus such as a processor or the like, a communication apparatus that performs wireless communication or wired communication, an electromechanical apparatus such as a motor or the like, a power supply apparatus, or the like.

An aspect of the present disclosure provides a technique advantageous for reducing radiated noise of a control circuit.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-018568, filed Feb. 6, 2025, which is hereby incorporated by reference herein in its entirety.

What is claimed is:

1. A control circuit for controlling a load circuit, the control circuit comprising:
a semiconductor element which has a first switching element and a second switching element integrated therein, wherein the first switching element is connected between a first output line connected to a first terminal of the load circuit and a first power supply line, and is configured to open and close flow of current to the load circuit, and wherein the second switching element is connected between a second output line connected to a second terminal of the load circuit and a second power supply line, and is configured to open and close flow of current to the load circuit;
a first capacitor connected between the first power supply line and the first output line;
a second capacitor connected between the second power supply line and the second output line; and
a circuit substrate on which the semiconductor element, the first capacitor, and the second capacitor are mounted.

2. The control circuit according to claim 1, further comprising:
a third switching element connected between the first output line and the second power supply line, and connected in series with the first switching element, wherein the third switching element is configured to open and close flow of current to the load circuit; and
a fourth switching element connected between the second output line and the first power supply line, and connected in series with the second switching element, wherein the fourth switching element is configured to open and close flow of current to the load circuit.

3. The control circuit according to claim 1, wherein the control circuit controls the load circuit by pulse width modulation control.

4. The control circuit according to claim 1, wherein the circuit substrate has a first surface on which a plurality of electrodes are provided,
wherein the semiconductor element is mounted on the first surface via the plurality of electrodes,
wherein the plurality of electrodes include:
a first electrode of the first output line; and
a second electrode of the second output line, and
wherein the first electrode and the second electrode are adjacent to each other.

5. The control circuit according to claim 4, wherein the plurality of electrodes include:
a third electrode of the first power supply line; and
a fourth electrode of the second power supply line, and
wherein the first electrode and the third electrode are adjacent to each other, and/or the second electrode and the fourth electrode are adjacent to each other.

6. The control circuit according to claim 1, further comprising:
a power supply configured to supply to the first power supply line,
wherein the second power supply line provides a ground.

7. The control circuit according to claim 5, wherein a first wiring, a second wiring, a third wiring, and a fourth wiring are provided on the first surface,
wherein the first capacitor is mounted on the first surface,
wherein the first electrode is connected to a terminal of the first capacitor via the first wiring,
wherein the third electrode is connected to an other terminal of the first capacitor via the third wiring,
wherein the second capacitor is mounted on the first surface,
wherein the second electrode is connected to a terminal of the second capacitor via the second wiring, and
wherein the fourth electrode is connected to an other terminal of the second capacitor via the fourth wiring.

8. The control circuit according to claim 7, wherein the first capacitor is adjacent to the semiconductor element, and
wherein the second capacitor is adjacent to the semiconductor element.

9. The control circuit according to claim 5, wherein the circuit substrate includes a first via, a second via, a third via, and a fourth via,
wherein the first capacitor is mounted on a second surface of the circuit substrate opposite to the first surface,
wherein the first via is configured for connection of the first electrode to a terminal of the first capacitor,
wherein the third via is configured for connection of the third electrode to an other terminal of the first capacitor,
wherein the second capacitor is mounted on the second surface,
wherein the second electrode is connected to one terminal of the second capacitor via the second via, and
wherein the fourth electrode is connected to the other terminal of the second capacitor via the fourth via.

10. The control circuit according to claim 9, wherein the first capacitor is arranged on the second surface so as to overlap the semiconductor element in a plan view of the first surface, and
wherein the second capacitor is arranged on the second surface so as to overlap the semiconductor element in the plan view.

11. The control circuit according to claim 5, wherein the first capacitor is mounted on the first surface,
wherein the first electrode is connected to a terminal of the first capacitor via a first solder ball,
wherein the third electrode is connected to an other terminal of the first capacitor via a third solder ball,
wherein the second capacitor is mounted on the first surface,
wherein the second electrode is connected to a terminal of the second capacitor via a second solder ball, and
wherein the fourth electrode is connected to an other terminal of the second capacitor via a fourth solder ball.

12. The control circuit according to claim 11, wherein the first capacitor is positioned between the semiconductor element and the circuit substrate, and
wherein the second capacitor is positioned between the semiconductor element and the circuit substrate.

13. The control circuit according to claim 1, further comprising:
a third switching element connected between a third output line and the first power supply line connected to a third terminal of the load circuit, wherein the third switching element is configured to open and close flow of current to the load circuit;
a fourth switching element connected between a fourth output line and the second power supply line connected to a fourth terminal of the load circuit, wherein the fourth switching element is configured to open and close flow of current to the load circuit;
a third capacitor connected between the first power supply line and the third output line; and
a fourth capacitor connected between the second power supply line and the fourth output line.

14. The control circuit according to claim 13, further comprising:
a fifth switching element connected between the first output line and the second power supply line, and connected in series with the first switching element, wherein the fifth switching element is configured to open and close flow of current to the load circuit;
a sixth switching element connected between the second output line and the first power supply line, and connected in series with the second switching element, wherein the sixth switching element is configured to open and close flow of current to the load circuit;
a seventh switching element connected between the third output line and the second power supply line, and connected in series with the third switching element, wherein the seventh switching element is configured to open and close flow of current to the load circuit; and
an eighth switching element connected between the fourth output line and the first power supply line, and connected in series with the fourth switching element, wherein the eighth switching element is configured to open and close flow of current to the load circuit.

15. The control circuit according to claim 1, wherein the semiconductor element includes:
a first output terminal in the first output line connected to the first terminal of the load circuit;
a first power terminal in the first power supply line;
a second output terminal in the second output line connected to the second terminal of the load circuit; and
a second power terminal in the second power supply line, and
wherein a distance between the first power terminal and the second power terminal is greater than a distance between the first output terminal and the second output terminal.

16. The control circuit according to claim 13, wherein the third switching element and the fourth switching element are integrated in the semiconductor element,
wherein the circuit substrate has a surface on which a plurality of electrodes are provided,
wherein the semiconductor element is mounted on the surface via the plurality of electrodes,
wherein the plurality of electrodes include:
a first electrode of the first output line;
a second electrode of the second output line;
a third electrode of the third output line; and
a fourth electrode of the fourth output line,
wherein the first electrode and the second electrode are adjacent to each other, and
wherein the third electrode and the fourth electrode are adjacent to each other.

17. The control circuit according to claim 16, wherein the plurality of electrodes further include:
a fifth electrode of the first power supply line;
a sixth electrode of the first power supply line; and
a seventh electrode of the second power supply line,
wherein the first electrode and the fifth electrode are adjacent to each other and the third electrode and the sixth electrode are adjacent to each other, and/or the second electrode and the seventh electrode are adjacent to each other and the fourth electrode and the seventh electrode are adjacent to each other.

18. An electrical apparatus comprising:
the control circuit according to claim 1 and the load circuit,
wherein the load circuit includes a load element having the first terminal and the second terminal, and
wherein the load element is configured as a motor configured as a stepping motor or a voice coil motor.

19. An electrical apparatus comprising the control circuit according to claim 13 and the load circuit,
wherein the load circuit includes:
a first load element having the first terminal and the second terminal; and
a second load element having the third terminal and the fourth terminal.

20. The electrical apparatus according to claim 19, wherein the first load element and the second load element are each a motor.

21. Equipment comprising:
the electrical apparatus according to claim 18; and
a movable element,
wherein the load circuit includes a motor configured to move the movable element.

22. The equipment according to claim 21, further comprising:
at least one of a housing or a lens barrel,
wherein the movable element is configured as an imaging element or an optical element housed in the housing or the lens barrel, respectively.
